(19) United States
(12) Patent Application Publication
(10) Pub. No.: US 2001/0052077 A1
(43) Pub. Date: Dec. 13, 2001

(54) Universal mobile ID system and method for digital rights management

(75) Inventors: Henry T. Fung, San Jose, CA (US); John Huan Zhao, San Jose, CA (US)

Correspondence Address: R. Michael Ananian, FLEHR HOHBACH TEST ALBRITTON & HERBERT LLP, Four Embarcadero Center, Suite 3400, San Francisco, CA, 94111-4187, US

(73) Assignee: INFOLIO, INC.

(21) Appl. No.: 09/916,838

(22) Filed: Jul. 27, 2001

Related U.S. Application Data
(63) Continuation of application No. 09/237,317, filed on Jan. 26, 1999.

(51) Int. Cl. H04L 9/00

(52) U.S. Cl. 713/184

(57) ABSTRACT

A system and method that allows client devices with different characteristics and users with different preferences to receive customized content from servers in an open, networked environment, regardless of the server's prior knowledge of the clients' configurations or the users' preferences. The embodiments allow the implementation of a secure, for-pay content delivery system wherein content providers can deliver paid content in an appropriate format over an open, networked environment, such as the Internet, to their subscribers without the fear of copyright violation. In particular, these embodiments prevent an authorized user from transferring to non-authorized users a key or other embodiment of a right that would allow the non-authorized users to access the for-pay content.

In one embodiment, each client is associated with a universal mobile ID (UMID) that designates the client's characteristics and a user's preferences. In one embodiment the UMID consists of two major parts: the User ID (UID) and the Device ID (DID). The UID includes information that is relevant to a user, including a unique, public personal identification number (PIN), preferences (e.g., what kind of news, sports, etc. the user is interested in) and access rights. The DID includes information that is relevant to a client device, including device attributes (e.g., display, processor type, multimedia capabilities, available memory size) and client date of birth (DOB). This information, which is transmitted by a client to a server with a content request, enables servers to customize content for clients about which they have no prior knowledge.

The present invention relates generally to networked computer systems and, particularly, to systems and methods for securely identifying a user and/or client computer accessing goods, services or support over a computer network.

### BACKGROUND OF THE INVENTION

As for-pay content, such as books, magazines, movies, computer programs, video games and sports, becomes available over the Internet, it is increasingly important for content providers to ensure that their material can only be accessed by customers with the appropriate rights (i.e., paying customers). It is also important the content be usable on the different types of platforms (e.g., personal computers, handheld devices, cellular phones) employed by users).

There are several solutions for ensuring that only authorized users access content. One such solution is described in U.S. Pat. No. 5,509,070, “Method for encouraging purchase of executable and non-executable software,” (the '070 patent), which is incorporated herein for background purposes. As stated in the Abstract, this patent discloses:

A method and apparatus of encouraging distribution, registration, and purchase of free copyable software and other digital information, which is accessed on a User's System via a Programmer's Program. Software tools which can be incorporated into a Programmer's Program allow the User to access Advanced Features of the Programmer's Program only in the presence of a valid Password which is unique to a particular Target ID generated on an ID-Target such as the User's system. Advanced features will thus re-lock if the Password is copied to another ID-target. If a valid Password is not present, the User is invited to obtain one, and provided with the means of doing so, and of installing that Password in a place accessible to the User's System on subsequent occasions. The present invention also provides Programmers with means to invoke business operations as well as computational operations with their programs, and thus to automatically obtain payment from Users who elect to obtain passwords.

The '070 patent does not address the twin problems of optimizing the content for the platform to which it is downloaded and customizing'the content to suit a user's preferences. The '070 patent also presumes a one-to-one relationship between the user and his platform. This limits the applicability of the invention in situations where multiple users, each possibly with different preferences and/or access rights, use a common platform to access for-pay content.

A method for customizing content to suit a user's preferences and client capabilities is described in U.S. patent application Ser. No. 08/742,092, “Intelligent Internetwork Communication System,” which is incorporated herein by reference. This patent application discloses a client/server system wherein a client relays requests for network content to a mediation server that retrieves the requested content and then, prior to returning the content, modifies it to be compatible with the platform's registered characteristics. These characteristics, which can include color depth, screen resolution, audio capabilities and memory size, are associated with each client via a client-specific ID that is stored in a mediation server database. The mediation server also can customize the content in accordance with registered user preferences and rights, which are associated with the same ID. Among other things, these preferences allow the platform user to tell the mediation server the preferred format of the downloaded content (e.g., image type, color depth, image scaling), display attributes (e.g., text only vs. full graphics) and security level (e.g., Internet access controls for children). This application does not address the problem of preventing copying of client IDs and the attendant problem of unauthorized use of for-pay content. This application also does not address the issue of assigning unique, relatively un-tamperable user and/or client IDs in an open environment, such as the Internet. Nor does this application describe how clients in an open environment can tell a server their device characteristics and user preferences to allow the server to appropriately customize requested for-pay content. Therefore, there is a need for an ID system and method that can be employed in open environments, such as the Internet, that provides a server with information about a client's capabilities and user preferences. There is a further need for an ID system and method that provides the above features in such as way as to prevent copying from client to another of the ID. There is a further need for such an ID system to be compatible with a secure system for providing for-pay content in open environments.

### SUMMARY OF THE INVENTION

In summary, embodiments of the present invention include systems and methods that allow client devices with different characteristics (e.g. display resolution, color depth, memory size, etc.) and users with different preferences to receive customized content from servers in an open, networked environment, regardless of the server's prior knowledge-of the clients' configurations or the users' preferences. The embodiments also include systems and methods that allow the implementation of a secure, for-pay content delivery system wherein content providers can deliver paid content in an appropriate format over an open, networked environment, such as the Internet, to their subscribers without the fear of copyright violation. In particular, these embodiments prevent an authorized user from transferring to non-authorized users a key or other embodiment of a right that would allow the non-authorized users to access the for-pay content.

In one embodiment, each client is associated with a universal mobile ID (UMID) that designates the client's characteristics and a user's preferences. In one embodiment the UMID consists of two major parts: the User ID (UID) and the Device ID (DID). The UID includes information that is relevant to a user, including a unique, public personal identification number (PIN), preferences (e.g., what kind of news, sports, etc. the user is interested in) and access rights. The DID includes information that is relevant to a client device, including device attributes (e.g., display, processor type, multimedia capabilities, available memory size) and client date of birth (DOB).

A user of a client who wishes to receive server content in accordance with the present invention first registers with the server, which, for the purposes of the present application, can be a conventional server or a mediation server. In one embodiment the user registers by sending the server a secret PIN that is, presumably, uniquely associated with the client from used to access the content. The secret PIN can either be stored in the client's non-volatile memory at the time of manufacture or can be generated by a client program from presumably unique client and/or user attributes and then stored on the client. In different embodiments the secret PIN can be generated as follows:

(1) Based on the assumption that no two clients are likely to be identical, hardware/software configuration information assumed to be unique for each client (e.g., Windows® registry information, dates of first creation of particular files) is used to generate the secret PIN.

(2) Based on the assumption that some bit patterns in files stored on the client can be altered without affecting the client's operation, hidden files are added or bits are altered in existing files in a manner that has no noticeable effects. Patterns of bits in the added files or modified bits in the existing files are then used to generate the secret PIN.

(3) Based on the assumption that two different persons can never be biologically identical, a set of one or more biometric measures, such as a person's handwriting, thumb print, voice print, retina pattern, typing pattern, etc., are used to generate the secret PIN.

The secret PIN is preferably transmitted to the server in a secure manner to avoid interception. Any type of encryption or other security approach could be employed for this purpose. Preferably, the secret PIN is stored on the client so that it cannot be easily copied.

After receiving the secret PIN the server determines the client characteristics and the user preferences in cooperation with the client. This can be done using an automated, machine-to-machine protocol in which the client responds to server queries or by the user responding to questions or forms sent by the user. From this information, the server assembles the UMID, which it returns to the client. In one embodiment, the UMID includes a public PIN assigned by the server that uniquely identifies the user.

Following registration, a user accesses server content by first issuing a request to the server along with his UMID. The server looks up the user's secret key using the public PIN and determines the client characteristics and user preferences based on the UID and DID contained in the UMID. In one embodiment, the server filters the content based on the UID and DID information, encrypts the content, and returns the encrypted content to the user along with a content-specific key. The user then decrypts the encrypted content using both his secret PIN and the content-specific key. Because the content-specific key only works with the secret PIN, which is not easily copied, the content-specific key only works on the intended client.

In those situations where a secret PIN could be copied, the client can include a program that checks the stored secret key against the actual system configuration or biometric measure initially used to generate the secret key. Such a system can also be used to allow multiple users to employ a single client to access server content.

In one embodiment, client programs and the users are allowed to modify some fields of the UMID before it is transmitted to the server. This allows the available memory, connection speed and client device locality, etc. to be modified dynamically and also allows a user to substitute a new set of preferences and access rights for the stored ones. This feature also allows a user to upgrade their client device and to indicate to the server the new features. This feature further allows a user to input a new PIN if they are using another person's client device.

### BRIEF DESCRIPTION OF THE DRAWINGS

Additional objects and features of the invention will be more readily apparent from the following detailed description and appended claims when taken in conjunction with the drawings, in which:

FIG. 1 is a block diagram of on open network environment in which the present invention can be practiced;

FIG. 2 is a flow diagram of a registration process cooperatively executed by a server and client;

FIG. 3 is a flow diagram of a content request procedure cooperatively executed by a server and client; and

FIG. 4A is a block diagram of a client computer configured in accordance with the present invention;

FIG. 4B is a block diagram of a server computer configured in accordance with the present invention; and

FIG. 5 shows the operation of one embodiment for generating a decryption factor Dfij 207ij that allows a user i to view content item j.

### DESCRIPTION OF THE PREFERRED EMBODIMENT

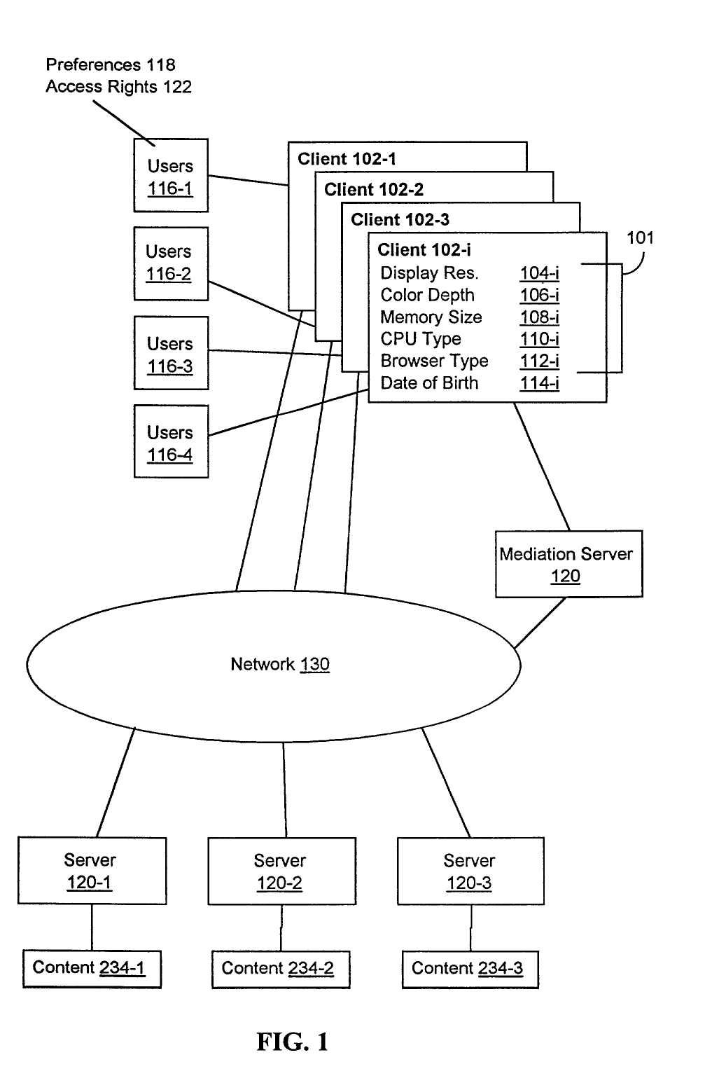

FIG. 1 is a block diagram of an open network environment in which the present invention can be practiced. This environment includes one or more client computers 102-i coupled to one or more servers 120 via a network 130. The clients 102 can be coupled to the network directly (e.g., via a direct connection or an Internet Service Provider) or via a mediation server 120, the operation of which is described in depth in U.S. application Ser. No. 08/742,092, which is incorporated herein by reference. It is immaterial to the present invention whether a mediation server 120 is employed. Each client 102 has a unique set of characteristics, such as display resolution 104 (e.g., SGVA, VGA, CGA), display color depth 106 (e.g., 1-bit, 8-bit, 24-bit), memory size 108i, CPU type 110, World Wide Web (WWW) browser type 112 and date of birth (DOB) 114 (i.e., date of manufacture). The characteristics are not limited to those shown in FIG. 1, which are merely illustrative. A non-exhaustive list of other capabilities might include communication channel speed, channel protocol and client locality (e.g., city, state, country, time zone, etc.).

Each client 102 can host one or more users 116, each of whom can access, via the client 102, content 234 stored on the servers 120. In some embodiments, the same user 116 can access content 234 from more than one client 102. However, in the interest of clarity, the first embodiment described herein is a simple embodiment that presumes a one-to-one relationship between clients 102 and users 116. The operation of the more flexible-embodiments (i.e., those that allow multiple users per client and multi-client users) is mostly apparent from the following description. Aspects of the more flexible embodiments that are not apparent from the description of the simple embodiment are described below.

Each user can have one or more preferences 118 that describe how they wish to interact with the server content 234. Possible preferences 118 include:

the type of content favored by the user (e.g., major league baseball, stock reports, weather for San Francisco, Calif.);

the preferred format of the downloaded content (e.g., image type, color depth, image scaling) when it differs from the client characteristics and

display attributes (e.g., text only vs. full graphics).

Each user can also have one or more access rights 122, which, for example, can be used to limit the access of children to the Internet.

Prior to requesting content 234 on behalf of a user 116, a client communicates one or more of the characteristics 101, preferences 118 and access rights 122 to the server 120 hosting that content 234. In light of this information the server customizes the downloaded content 234 for the client 102 and user 116. Some techniques for customizing the content 234 (e.g., reducing color depth and data resolution) are described in the incorporated U.S. patent application Ser. No. 08/742,092, which is incorporated herein by reference.

Each client 102 (or user) also has a unique, secret and difficult (if not impossible) to transfer identification (ID) that is securely transmitted to a server 120 whenever the client's user 116 wishes to register with the server 120 to receive content 234. Based on this secret ID, the server 120 determines a secure transfer mode that will allow only the requesting user to access content downloaded to them.

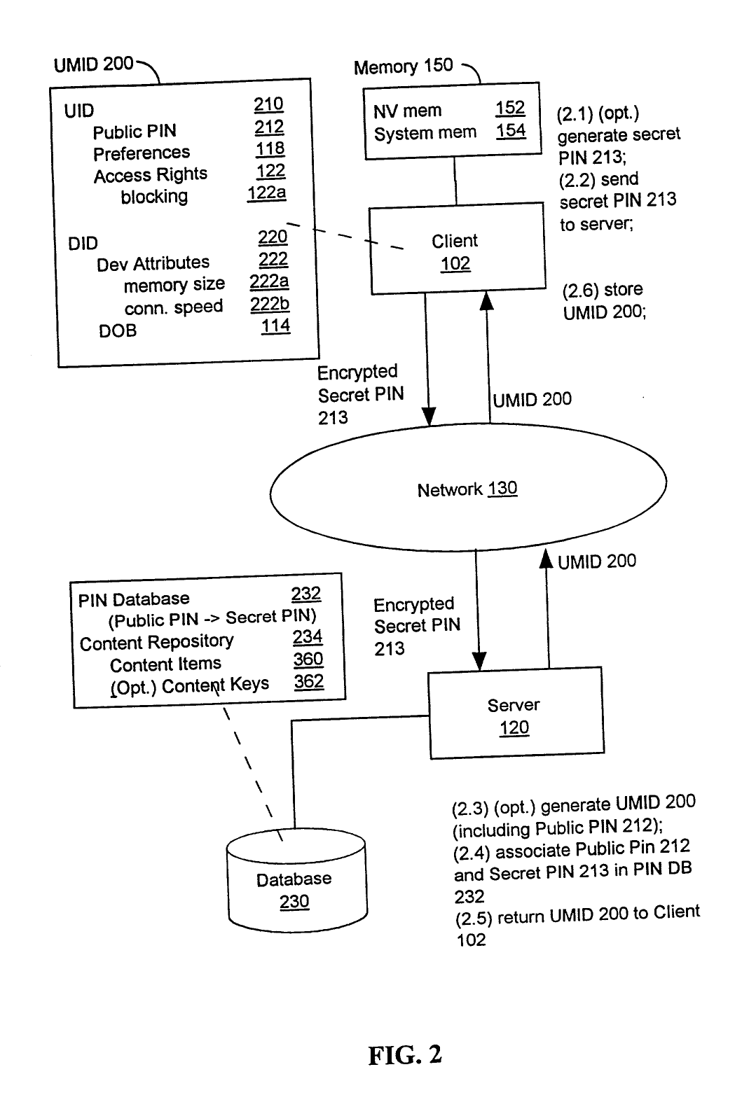

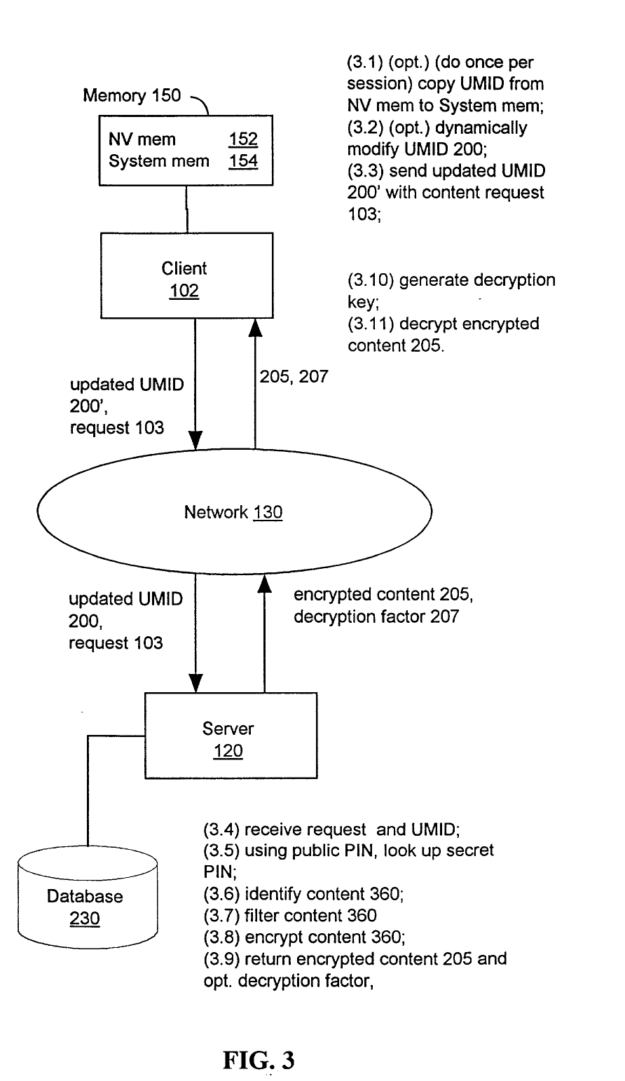

Accordingly, the present invention can be the basis for a secure, for-pay content delivery system wherein content providers can deliver paid content in an appropriate format over an open, networked environment, such as the Internet, to their subscribers without the fear of copyright violation. A particular feature of all embodiments is that an authorized user is unable to transfer access-rights to non-authorized users. Registration and content access methods are now described with reference to FIGS. 2 and 3.

FIG. 2 is a flow diagram of a registration process cooperatively executed by a server 120 and a client 102. This figure shows key data and hardware components and enumerates steps of the registration process. In the illustrated embodiment, steps (2.1), (2.2) and (2.6) are performed by the client 102 and the remaining steps by the server 120; however, other step sequences are also possible. In the conventional manner, the client 102 is presumed to have a memory 150, including non-volatile memory 152 and volatile, system memory 154. The server 120 is presumed to have access to a database 230.

Among other things, the client memory 150 stores a universal mobile ID (UMID) 200 that has two components: a user ID (UID) 210 that summarizes user-specific data and a device ID (DID) 220 that summarizes device-specific data. The UMID can be stored in non-volatile memory 152 (if the client is so-configured) or the system memory 152, 154. The UID 210 includes, but is not limited to, a public PIN 212, user preferences 118 and access rights 122. The DID 220 includes device attributes/characteristics 222 and the clients's date of birth (DOB) 114. The fields of the UID 210 and DID 220 are described in Table 1.

TABLE 1

| ID | Field | Definition |
|---|---|---|
| UID 210 | Public PIN 212 | a n-bit, id that is unique for every |
| | | device |
| | User | specifies preference of the user in |
| | Preferences 118 | areas such as sports, news, finance |
| | | and etc. |
| | Access | contains information about the |
| | Rights 122 | access right, such as child access to |
| | | some pre-defined web sites (could be |
| | | similar to the V-chip used by the TV |
| | | industry) |
| DID 220 | Device | contains characteristics about the |
| | Attributes 222 | device, such as CPU type, display |
| | | size, color depth, available memory |
| | | size, etc. |
| | Date of | the date when the device was |
| | Birth 114 | manufactured |

In one embodiment, the public PIN 212 is at least n-bits long so that the total number of assignable IDs m is much smaller than the number 2ⁿ (i.e. m<<<2ⁿ). This is to prevent someone from making counterfeits by just picking any one number as the public PIN. In one embodiment, the UMID 200 is programmed at the factory and stored in the non-volatile memory 152. In an alternative embodiment, which is shown in FIG. 2, the UMID is generated by a server 120. The information in the UMID 200 is not limited to the above-described fields. Generally, the UMID 200 can include any user or device information that could be of use to the server. For example, the user information 210 could include credit or debit information to support on-line commerce and could designate particular publications to which the user wishes to subscribe. The device information 220 could include any hardware or software information associated with the client that could influence the type/size of content that can be downloaded to and/or used by the client 102.

The present invention requires each user/client combination to have a unique, secret PIN 213, the purpose of which is described later. In one embodiment, the secret PIN 213 is at least n-bits long so that the total number of assignable IDs m is much smaller than the number 2ⁿ (i.e. m<<<2ⁿ). This is to prevent someone from making counterfeits by just picking any one number as the secret PIN. In one embodiment, the secret PIN 213 is programmed at the factory and stored in the non-volatile memory 152. However, there are millions of open platforms that could be used as a client 102 that are not pre-programmed with either a UMID 200 or secret PIN 213. The embodiment shown in FIG. 2 addresses this problem in an optional first step (2.1) wherein the client 102 generates the secret PIN 213, which is stored in either the system or NV memory 152, 154. In similar embodiments, the secret PIN 213 can be downloaded from the server 102.

In different embodiments the client 102 generates the secret PIN using information that is unique to the client and/or user and cannot reasonably be copied. Such information could include, but is not limited to, unique client hardware and/or software characteristics, unique user interactions with the client device, or user biometrical data. Possible methods for generating the PIN include the following:

(1) Based on the assumption that no two clients are likely to be identical, hardware/software configuration information assumed to be unique for each client (e.g., Windows® registry information, dates of first creation of particular files) is used to generate the secret PIN.

(2) Based on the assumption that some bit patterns in files stored on the client can be altered without affecting the client's operation, hidden files are added or bits are altered in existing files in a manner that has no noticeable effects. Patterns of bits in the added files or modified bits in the existing files are then used to generate the secret PIN.

(3) Based on the assumption that two different persons can never be biologically identical, a set of one or more biometric measures, such as a person's handwriting, thumb print, voice print, retina pattern, typing pattern, etc., are used to generate the secret PIN.

However the secret PIN 213 is created, it is preferably stored on the client 102 in such a manner that it cannot be easily copied. Any number of techniques known in the art can be used for this purpose. These techniques range from providing special-purpose hardware protection to prevent easy access to the secret PIN 213 in the non-volatile memory 152, to writing parts of the secret PIN 213 to randomly generated secret files or to non-functional bit patterns in existing files.

Assuming the existence of a secret PIN stored on the client 102, a user who wishes to receive server content in accordance with the present invention first registers with the server 102. In one embodiment the user registers by sending the server the secret PIN 213 (2.2). Preferably, this transmission and all other client/server transmissions are transmitted in a secure manner to avoid interception. Any type of encryption or other security approach can be employed for this purpose.

After receiving the secret PIN the server 102 determines the client characteristics and the user preferences in cooperation with the client. This can be done using an automated, machine-to-machine protocol in which the client responds to server queries, or by the user responding to questions or forms sent by the server 120. From this information, the server 120 assembles the UMID 200 (2.3), which it returns to the client (2.5). In one embodiment, the UMID includes a public PIN 212, assigned by the server, that uniquely identifies the user/client. This step (2.3) of generating the UMID 200 is optional if the UMID 200 was factory-programmed into the client 102. The server 120 then associates the public PIN 212 with the secret PIN 213 sent by the client (2.4). In one embodiment, the server does this by making a new entry in the server database 230. However, any other technology can be used by the server to record this relationship. The client 102 stores the UMID 200 (2.6) in the non-volatile memory to ensure its continued availability or just in system memory if NV memory is not available. The UMID 200 can be stored without security precautions as the UMID is intended to be publicly exchanged with any server 102 to initiate the transmission of content. This content transmission process is now described with reference to FIG. 3.

FIG. 3 is a flow diagram of a content request procedure cooperatively executed by a server 120 and client 102. The first step (3.1) is not actually performed for every content request from a client, but is performed only once after the client is powered-up and only if the client has a non-volatile memory 152 in which the UMID 200 is stored. In this step, the client 102 copies the entire UMID 200 (FIG. 2) from the non-volatile (NV) memory 152 to the system memory 154. Once in the system memory, at least a portion of the UMID 200 can be modified (3.2) to form an updated UMID 200′.

In one embodiment, all or some of the UID 210 and DID 220 fields (FIG. 2) can be dynamically modified by the user 116 and/or the client 102. For example, a user can enable a blocking parameter 122a in the access rights field 122 to allow his child to use the client device 102. By the same token, the client 102 can freely and dynamically modify an available memory size parameter 222a in the device attributes field 222 to prevent the server 120 from sending the client 102 more data than it has memory to handle. This feature is particularly useful for clients 102 with a very small amount of available memory. In one embodiment, depending on the value in a communication speed parameter 222b, the server 120 can decide what type of content 360 should be downloaded to the client 102. For example, the server 120 might send just text and not streaming video over a 14.4 kilobit per second connection.

Other device features 222 that might be dynamically modified include any device parameters that impact at least one of:

(1) size of the content that can be stored in client memory;

(2) bandwidth of the content that can be transmitted between the client computer and the server computer;

(3) complexity of the content that can be accessed by the client computer; and

(4) geographic relevance of the content.

In addition to those described above, these parameters could include, but are not limited to: available network capacity, processor capability, available processor capacity, client geographic position, and client time zone. A user 116 accesses server content by issuing a content request 103 to the server 120 along with the updated UMID 200′ (3.3) (hereinafter, references to the “UMID 200′” should be understood also to refer to the UMID 200). Upon receiving the request 103 and the UMID 200′ (3.4), the server 120 retrieves the user's secret PIN 213 from the PIN database 232 using the public PIN 212 (3.5) and identifies the requested content item(s) 360 in the content repository 234 (3.6). The server 120 filters the content 360 based on the client device attributes 222 and user preferences 118 (3.7), and then, if encryption is required, encrypts the filtered content 360 using an encryption key 236 that is a function of the secret PIN 213 and, optionally, any key(s) 362 associated with the content 360 (3.8). This encryption can be accomplished using well-known encryption techniques. For example, in the general situation where the client and the server were not known to one another at birth, the encryption can be any single key, shared key or public key technique. As disclosed in the U.S. patent application Ser. No. 08/742,092, when the client 102 and server 120 are known to each other at birth, other types of encryption can be employed, such as one-time pad encryption, that require prior knowledge between the parties.

Depending on the encryption scheme, the server 120 either returns just the encrypted content 205 (assuming the client 102 is able to decrypt the content using only internal information, such as the secret PIN 113), or the encrypted content 205 and a decryption factor (DF) 207 that must be used by the client 102 in conjunction with the secret PIN 213 to decrypt the content 205 (3.9). In the latter embodiments, because the content-specific decryption factor 207 only works with the secret PIN 213, which is not easily copied, the content 360 can only be read by the intended client. Depending on the encryption scheme, the decryption factor 207 can either be used in conjunction with the secret PIN 213 to recover the content key directly, or to derive a decryption key that is paired with the content key.

The client 102 subsequently generates a decryption key (3.10) and decrypts the content 360 using that decryption key (3.11). When a decryption factor 207 is sent by the server 120, the decryption key is a function of the decryption factor 207 and the secret PIN 213. Otherwise, the decryption factor is a function of the secret PIN 213 alone.

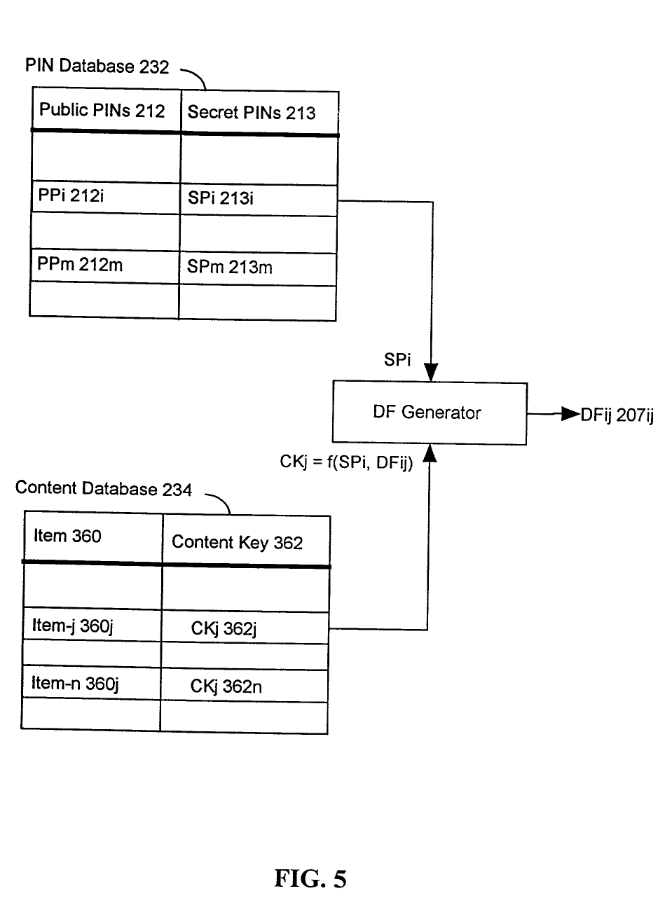

FIG. 5 shows the operation of one embodiment for generating a decryption factor DFij 207ij that allows a user 116i to view a content item 360j. In this embodiment, the PIN database 232 maps public PINS 212 to secret PINS 213 for all registered users 1 . . . m. The content database 234 associates with each item 360 a content key 363 for all items 1 . . . n. Each content item 360 can be stored in encrypted form or can be encrypted with its content key 363 prior to downloading to the client computer 102. In any of the embodiments, an item 360 can be all or part of a for-pay work. For example, each different type of information in a magazine (text and pictures) could be treated as a separate content item 360 with its own content key 363. Different chapters of a book could be treated in the same manner. When a user 116i requests a content item 360j, the server couples the associated content key (CKj) 362j and secret PIN (SPi) 213i to a decryption factor (DF) generator 380. The DF generator 380 in response generates a decryption factor DFij 207ij that can be used by the client of the user 116i in combination with user's secret PIN 213i to access the item 360j. The relationship between the secret PIN (SP), decryption factor (DF) and content key (CK) can be represented as follows:

CKj=f(SPi, DFij),

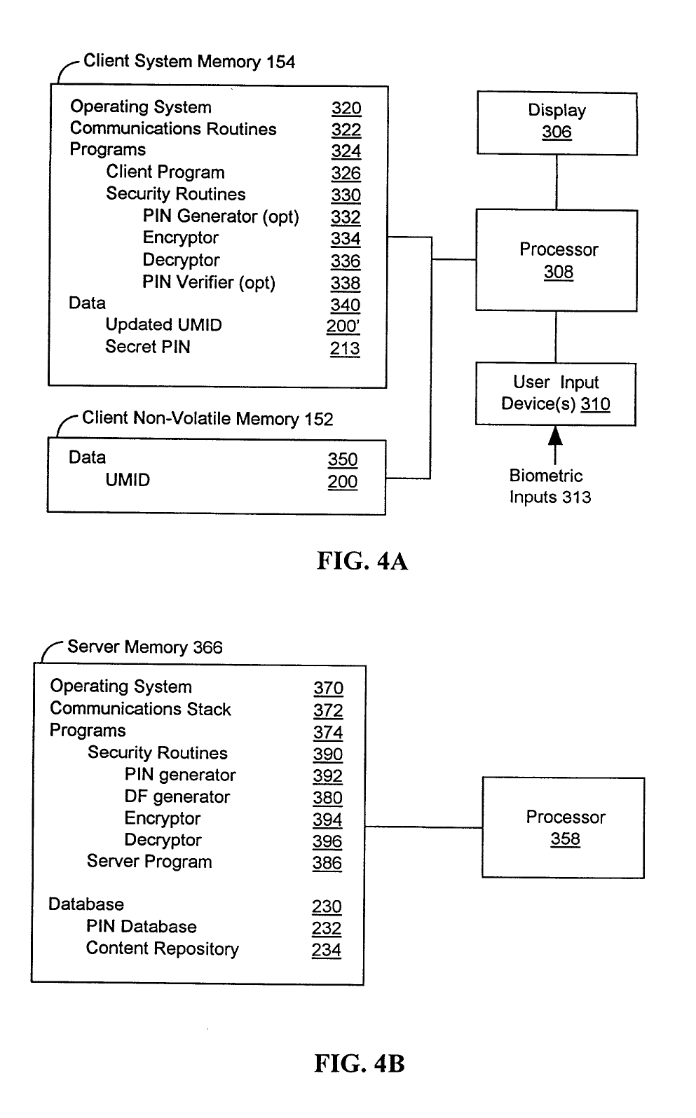

which denotes that the j^{th} content key is a function of the i^{th} secret PIN and the i-j^{th} decryption factor. The function f can be any function such that a DFij can always be determined given a CKj and SPi. The DF generator 380 solves this expression for DFij given the SPi and CKj read out from the PIN database 232 and the content database 234, respectively. Configurations of a client 102 and a server 120 in which the present invention can be implemented are now described with reference to FIGS. 4A and 4B.

FIG. 4A is a block diagram of a client computing device 102 embodiment that includes a client system memory 154, NV memory 152, display 306, processor 308 and input device(s) 310. The input device is configured to receive user inputs, including biometric inputs 313 needed to generate and verify PINs 213. The client system memory 154, which could be any combination of a fast, semiconductor memory, such as a RAM, or a slower, magnetic memory, includes an operating system 320, communication routines 322 for interacting with the network 130 and the servers 120, programs 324 and data 340. The data 340 can include client data generated by the client or downloaded from the server 120, such as the update UMID 200′ and the secret PIN 213. The optional NV memory 152 can include important data 350, such as the UMID 200. In the conventional manner, the communication routines 322 and the programs 324 execute in the processor 308 under control of the operating system. Among other things, the operating system 320 provides program access to peripherals, such as the display 306, which are employed by users to interact with (e.g., view, listen to, play, record onto, etc.) the downloaded content 360. In one embodiment, the programs 324 include a client program 326 and security routines 330, which further include an optional PIN generator 332, encryptor 334, decryptor 336 and PIN verifier 338.

The client program 326 performs, with possible support from the security routines 330, the client operations described with reference to FIGS. 2 and 3. In embodiments where the client 102 is not factory-configured with the secret PIN 213, the client program 326 can invoke the optional PIN generator program 332 to generate the secret PIN 213. The PIN generator 232 can use one of the techniques described above (i.e., biometric data, random bit patterns, random user-input) or similar techniques to generate the PIN 213.

In embodiments where the PIN is generated by the PIN generator program 332 from biometric data, or other reproducable, user-specific data, the client program 326 can employ the optional PIN verifier 338 to ensure that the user 116 who is attempting to access downloaded content 360 is authorized to do so. The optional PIN verifier 338 does this by prompting the user 116 to supply the biometric inputs (e.g., signature or other writing, fingerprint, voice input, retina scan, etc.) or other data from which the secret PIN 213 was originally generated and determining whether the input matches the input originally used to generate the secret PIN 213. The client program allows the user to unlock the content 360 only if the verifier 338 verifies the match. This scheme is particularly useful in embodiments where multiple users 116 share one client. In this situation, secret keys for the different users are stored on the client device 102. PIN verification is performed whenever content is downloaded to the client 102 to ensure that is only viewed by the authorized user 116. This scheme also allows users 116 to be guest users of other clients 102.

Generating the secret PIN 213 from biometric data has another value. In this situation, as the user essentially carries the secret PIN with them, there is no need to store the PIN 213 on the client at any time. Instead, at registration (see FIG. 2), the PIN generator 332 prompts the user for their biometric inputs, generates the secret PIN 213 and sends it in encrypted form to the server 120 without ever storing the PIN 213 on the client 102. The server subsequently uses the secret PIN 213 to determine how to encrypt the requested content 360. To subsequently access the downloaded content the user simply provides the correct biometric inputs, which are verified by the PIN verifier 338. Yet another advantage of being able to process biometric inputs on the client 102 is that the PIN 213, however generated, can be encrypted using an encryption key generated from biometric data and then stored on the client 102. In this situation, the PIN verifier 338 would be configured to unlock the secret PIN 213 only for the user who can provide the correct biometric inputs. This scheme would be useful in systems where multiple users access content 360 through a single client 102 and would discourage copying of secret PINs 213.

The client program 326 employs the encryptor 334 to encrypt secret PINS 213 sent to the server 120 during registration and employs the decryptor 336 to decrypt encrypted content 205 returned by the server 120. One server embodiment is now described with reference to FIG. 4B.

FIG. 4B is a block diagram of a server computer 120 embodiment that includes a server memory 366 and processor 358. The server memory 366, which could be any combination of a fast, semiconductor memory, such as a RAM or a slower, magnetic memory, includes an operating system 370, communication routines 372 for interacting with the network 130 and the clients 102, programs 374 and a database 230. In the conventional manner, the communication routines 372 and the programs 374 execute in the processor 358 under control of the operating system 370. In one embodiment, the programs 374 include a server program 386 and security routines 390, which further include an optional PIN generator 392, DF generator 380, encryptor 394, decryptor 396 and PIN verifier 398.

The server program 386 performs, with possible support from the security routines 390, the server operations described with reference to FIGS. 2, 3 and 5. In embodiments where the client 102 is not factory-configured with the secret PIN 213, the server program 386 can invoke the optional PIN generator program 392 to generate the secret PIN 213. The PIN generator 232 can use one of the techniques described above (i.e., biometric data, random bit patterns, random user-input, random number generation) or similar techniques to generate the PIN 213, which is subsequently encrypted prior to be returned to the client 102.

The operation of the DF generator 380 has already been described with reference to FIG. 5. The server program 386 can employ the encryptor 394 to encrypt information sent to the client 102 and can employ the decryptor 336 to decrypt encrypted information, such as the secret PIN 213, sent by the client 102.

In another embodiment, content providers can allow any client 102 to download content 360 to try out for a period of time or to pass to their friends. After some limit has expired, a window will be opened on the client's screen to inform the user that payment must be made if he wants to continue to use the content.

In particular, one embodiment of the present invention is a universal mobile ID (UMID) system for use in a computer system including a client computer 102 employed by a user and a server computer 120 from which the client computer downloads content 360 via a network. This embodiment includes a public PIN 212 associated with the client computer and at least one of: user-specific information and device specific information. The user-specific information includes at least one of: user preferences 118 that can be used by the server to filter the content and access rights 122 that can be used by the server to limit access of the user to the content. The device-specific information includes at least one of: device attributes 222 of the client that can be used by the server to customize the content so that it is suitable for use on the client and date of birth (DOB) 114 of the client. At least a subset of the user preferences, access rights and device attributes are dynamically modifiable by any combination of the user and a client program 326 executing on the client computer 102. The public PIN, user-specific information and device-specific information are transmitted to the server 120 by the client 102 to enable the server to appropriately configure the content to be downloaded to the client.

A related embodiment includes a secret PIN 213 associated with the client 102 that is accessible to the client and the server 120. The secret PIN 213 is used by the server, when the content 360 is encrypted, to generate a decryption factor 207 with which the client 102, in conjunction with the secret PIN 213, can decrypt the encrypted content. The secret PIN can be managed in many different ways, including:

(1) The secret PIN is stored on both the client and the server at birth.

(2) The secret PIN is stored on the client 102 and is encrypted prior to storage with an encryption key derived at least partially using biometric information taken from the user.

(3) The secret PIN is generated by a client security program 332 executing on the client and is transmitted to the server in a secure manner.

In different embodiments the secret PIN 213 can be generated in many different ways, including: hardware/software configuration information assumed to be unique for the client, patterns of bits in selected files stored on the client, and a set of biometric information 313 associated with the user.

In one embodiment, when the secret PIN 213 is generated using biometric information 313, the secret PIN is not stored on the client. Alternatively, if the secret PIN is stored on the client it is stored in a secure manner.

In one embodiment, the public PIN 212, user-specific information, device-specific information and date of birth (DOB) 114 are stored on the client at birth. In another embodiment, the public PIN, user-specific information and device-specific information are generated by the server in response to questions answered by the user and then downloaded to the client.

In various embodiments, the user preferences 118 can include: types of content in which the user is interested, image type, color depth, image scaling, and display attributes. The access rights 122 can include blocking rights 122a. The device attributes 222 can include: memory size 222a, connection speed to the network 222b, and client device locality.

Another embodiment is a method for providing digital rights management in an open, networked environment wherein a client computer is employed by a user to download content from a server computer via a network. The method embodiment includes:

assigning the client a secret PIN 213;

registering the secret PIN with the server 120;

assigning the client a universal mobile ID (UMID) 200, which includes:

a public PIN 212 associated with the client computer; and at least one of:

user-specific information, including at least one of:

user preferences 118 that can be used by the server to filter the content; and

access rights 122 that can be used by the server to limit access of the user to the content; and

device-specific information, including at least one of:

device attributes 222 of the client that can be used by the server to customize the content so that it is suitable for use on the client; and

date of birth (DOB) 114 of the client;

associating in the server 120 the secret PIN and the public PIN;

determining content 360 stored on the server to be downloaded to the client;

customizing content to be downloaded to the server using at least a subset of the UMID 200;

encrypting on the server 120 the content to be downloaded;

downloading the encrypted content 205 to the client; and

decrypting on the client the encrypted content using a decryption key derived from the secret PIN.

In another embodiment, the method can also include: associating with a content item 360 a respective content key 362, encrypting the content item 360 with the respective content key 362, and determining from the content key associated with the content to be downloaded and the secret PIN 213 of the user a decryption factor 207. In this embodiment, the client employs the decryption factor and the secret PIN to derive the decryption key, which the client uses to access the encrypted content.

Yet another embodiment encompasses a secret PIN 213 associated with a client 102 configured to download encrypted content 205 from a server 120. In this embodiment:

the secret PIN 213 is accessible to the client and the server;

the secret PIN is used by the server to generate a decryption factor 207 with which the client, in conjunction with the secret PIN, can decrypt the encrypted content 205;

the secret PIN 213 is generated by the client 102 anytime it is needed; and

neither the secret PIN 213 nor data used to generate the secret PIN 213 are stored on the client 102.

An additional embodiment is a dynamic, universal mobile ID 200 for use in a client computer 102 configured to download content 360 from a server computer 120. The dynamic, universal mobile ID includes device information 222 that describes configuration of the client. At least a subset of the device information 222 can be dynamically modified by the client computer. The dynamic universal mobile ID 200 is transmitted to the server computer 120 to enable the server computer to customize the content 360 to be downloaded to the client computer 102.

In a particular embodiment, the subset of the device information includes device parameters impacting at least one of: size of the content that can be stored in client memory, bandwidth of the content that can be transmitted between the client computer and the server computer, complexity of the content that can be accessed by the client computer, and geographic relevance of the content.

In a particular embodiment of the dynamic, universal mobile ID, the device parameters 222 can include at least one of: network connection speed between the client and server computers, available network capacity, processor capability, available processor capacity, available client memory, client geographic position, and client time zone. Another embodiment is a method for enabling a client computer 102 to download and use encrypted content 205 from a server computer 120. This method includes a registration phase and a downloading phase. The registration phase includes: the client 102 transmitting to the server 120 a secret PIN 213 associated with the client computer 102, and the server 120 associating with the secret PIN 213 a public PIN 212 associated with the client computer 102. The downloading phase includes: the client 102 issuing a request 103 to the server 120 for the encrypted content, the client identifying itself as the source of the request using the public PIN 212, the server looking up the secret PIN 213 using the public PIN, the server 120 generating a decryption factor 207 based on the secret PIN 213 that can be used by the client 102 in conjunction with the secret PIN 213 to decrypt the encrypted content 205, and the server 102 transmitting the encrypted content 205 and the decryption factor 207 to the client 102.

In an alternate embodiment, a user 116 can receive content 360 from the server 120 without issuing a request 103. Instead, in what is referred to as push-mode operation, the user 116 can subscribe to particular types of content specified in their UMID 200, which the server 120 downloads as appropriate (e.g., whenever the next edition of an online newspaper to which the user subscribes is published). The server 120 can charge the client for any for-pay information using credit or debit information that could be contained in the UMID 200 or sent to the server 120 during the registration phase.

While the present invention has been described with reference to a few specific embodiments, the description is illustrative of the invention and is not to be construed as limiting the invention. Various modifications may occur to those skilled in the art without departing from the true spirit and scope of the invention as defined by the appended claims.

What is claimed is:

1. A universal mobile ID (UMID) system for use in a computer system including a client computer employed by a user and a server computer from which the client computer downloads content via a network, comprising:
a public PIN associated with the client computer; and at least one of:
user-specific information, including at least one of:
user preferences that can be used by the server to filter the content; and
access rights that can be used by the server to limit access of the user to the content; and
device-specific information, including at least one of:
device attributes of the client that can be used by the server to customize the content so that it is suitable for use on the client; and
date of birth (DOB) of the client; at least a subset of the user preferences, access rights and device attributes being dynamically modifiable by any combination of the user and a client program executing on the client computer; and
the public PIN, user-specific information and device-specific information being transmitted to the server by the client to enable the server to appropriately configure the content to be downloaded to the client.

2. The UMID system of claim 1, further comprising:
a secret PIN associated with the client accessible to the client and the server;
wherein the secret PIN is used by the server, when the content is encrypted, to generate a decryption factor with which the client, in conjunction with the secret PIN, can decrypt the encrypted content.

3. The UMID system of claim 2, wherein the secret PIN is stored on both the client and the server at birth.

4. The UMID system of claim 3, wherein:
the secret PIN stored on the client is encrypted prior to storage with an encryption key derived at least partially using biometric information taken from the user.

5. The UMID system of claim 1, wherein the secret PIN is generated by a client security program executing on the client and is transmitted to the server in a secure manner.

6. The UMID system of claim 5, wherein the secret PIN is generated using at least one of:
(1) hardware/software configuration information assumed to be unique for the client,
(2) patterns of bits in selected files stored on the client; and
(3) a set of biometric information associated with the user.

7. The UMID system of claim 6, wherein the biometric information includes at least one of:
handwriting characteristics;
one or more fingerprints;
voice print;
retina pattern; and
typing pattern.

8. The UMID system of claim 6, wherein, when the secret PIN is generated using the biometric information, the secret PIN is not stored on the client.

9. The UMID system of claim 6, wherein the secret PIN is stored on the client in a secure manner.

10. The UMID of claim 9, wherein, when the secret PIN is derived using the biometric information, prior to storage the secret PIN is encrypted with an encryption key derived at least partially using the biometric information.

11. The UMID of claim 1, wherein the public PIN, user-specific information, device-specific information, and date of birth (DOB) are stored on the client at birth.

12. The UMID of claim 1, wherein the public PIN, user-specific information and device-specific information are generated by the server in response to questions answered by the user and then downloaded to the client.

13. The UMID of claim 1, wherein:
the user preferences include:
types of content in which the user is interested;
image type;
color depth;
image scaling;
display attributes;
the access rights include blocking rights; and
the device attributes include:
memory size;
connection speed to the network; and
client device locality.

14. A method for providing digital rights management in an open, networked environment wherein a client computer is employed by a user to download content from a server computer via a network, comprising:
assigning the client a secret PIN;
registering the secret PIN with the server;
assigning the client a universal mobile ID (UMID), which includes:
a public PIN associated with the client computer; and at least one of:
user-specific information, including at least one of:
user preferences that can be used by the server to filter the content; and
access rights that can be used by the server to limit access of the user to the content; and
device-specific information, including at least one of:
device attributes of the client that can be used by the server to customize the content so that it is suitable for use on the client; and
date of birth (DOB) of the client;
associating in the server the secret PIN and the public PIN;
determining content stored on the server to be downloaded to the client;
customizing content to be downloaded to the server using at least a subset of the UMID;
encrypting on the server the content to be downloaded;
downloading the encrypted content to the client; and
decrypting on the client the encrypted content using a decryption key derived from the secret PIN.

15. The digital rights management method of claim 14, further comprising:
associating with a content item a respective content key;
encrypting the content item with the respective content key;
determining from the content key associated with the content to be downloaded and the secret PIN of the user a decryption factor;
the client employing the decryption factor and the secret PIN to derive the decryption key without which the client cannot access the encrypted content.

16. The digital rights management method of claim 14, wherein the secret PIN assigning step comprises setting the secret ID at the time of manufacturing of the client.

17. The digital rights management method of claim 14, wherein the secret PIN assigning step comprises generating the secret PIN using a client security program executing on the client.

18. The digital rights management method of claim 17, wherein the secret PIN generating step comprises generating the PIN as a function of at least one of:
(1) hardware/software configuration information assumed to be unique for the client;
(2) patterns of bits in selected files stored on the client; and
(3) a set of biometric information associated with the user.

19. The digital rights management method of claim 18, wherein the biometric information includes at least one of:
handwriting characteristics;
one or more fingerprints;
voice print;
retina pattern; and
typing pattern.

20. The digital rights management method of claim 14, further comprising storing the secret PIN on the client in a secure manner.

21. The digital rights management method of claim 24, wherein the step of storing the secret PIN on the client in a secure manner comprises:
when the secret PIN is derived using the biometric information, encrypting the secret PIN with an encryption key derived at least partially using the biometric information, neither the encryption key nor an associated decryption key ever being permanently stored on the client, such that, when necessary, the client derives the decryption key and the encryption key using the biometric information.

22. The digital rights management method of claim 14, wherein the UMID assigning step comprises the server generating the public PIN, user-specific information and device-specific information in response to questions answered by the user and then downloading the UMID to the client.

23. The digital rights management method of claim 14, wherein:
the user preferences include:
types of content in which the user is interested;
image type;
color depth;
image scaling;
display attributes;
the access rights include blocking rights; and
the device attributes include:
memory size;
connection speed to the network; and
client device locality.

24. The digital rights management method of claim 14, further comprising the step of:
allowing any combination of the user and a client program to dynamically modify at least a subset of the user preferences, access rights and device attributes.

25. The digital rights management method of claim 24, further comprising:
when the device attributes include memory size, allowing the client program to dynamically modify the memory size in accordance with memory available in the client; and
the server modifying the content accordingly so that the content downloaded from the server fits in the memory available in the client.

26. The digital rights management method of claim 24, further comprising:
when the device attributes include connection speed, allowing the client program to dynamically modify the connection speed in accordance with current speed of client connection to the network; and
the server modifying the content accordingly so that the content downloaded from the server is compatible with the connection speed.

27. The digital rights management method of claim 14, wherein the content is for-pay content, further comprising:
paying the server for the content prior to the downloading step.

28. A secret PIN associated with a client configured to download encrypted content from a server, wherein:
the secret PIN is accessible to the client and the server;
the secret PIN is used by the server to generate a decryption factor with which the client, in conjunction with the secret PIN, can decrypt the encrypted content;
the secret PIN is reliably generated by the client anytime it is needed; and
neither the secret PIN nor data used to generate the secret PIN are stored on the client.

29. The secret PIN of claim 28, wherein the secret PIN is generated by a client security program executing on the client and is transmitted to the server in a secure manner.

30. The secret PIN of claim 29, wherein the secret PIN is generated using a set of biometric information associated with the user.

31. The UMID system of claim 30, wherein the biometric information includes at least one of:
handwriting characteristics;
one or more fingerprints;
voice print;
retina pattern; and
typing pattern.

32. A dynamic, universal mobile ID for use in a client computer configured to download content from a server computer, comprising:
device information that describes configuration of the client;
at least a subset of the device information being dynamically modifiable by the client computer;
the dynamic universal mobile ID being transmitted to the server computer to enable the server computer to customize the content to be downloaded to the client computer;

33. The dynamic, universal mobile ID of claim 32, wherein the subset includes device parameters impacting at least one of:
size of the content that can be stored in client memory;
bandwidth of the content that can be transmitted between the client computer and the server computer;
complexity of the content that can be accessed by the client computer; and
geographic relevance of the content.

34. The dynamic, universal mobile ID of claim 32, wherein the device parameters include at least one of:
network connection speed between the client and server computers;
available network capacity;
processor capability;
available processor capacity;
available client memory;
client geographic position; and
client time zone.

35. The dynamic, universal mobile ID of claim 32, wherein the content is subscription content, further comprising:
subscription information indicating particular types of subscription content;
the server downloading the subscription content as appropriate in a push mode operation.

36. The dynamic, universal mobile ID of claim 35, further comprising:
payment information;
the server charging the client for downloaded subscription content using the payment information.

37. The dynamic, universal mobile ID of claim 35, wherein the server charges the client for downloaded subscription content using payment information forwarded to the server by the server in a separate registration operation.

38. A method for enabling a client computer to download and use encrypted content from a server computer, comprising:
a registration phase, including:
the client transmitting to the server a secret PIN associated with the client computer; and
the server associating with the secret PIN a public PIN associated with the client computer; and
a downloading phase, including:
the client issuing a request to the server for the encrypted content;
the client identifying itself as the source of the request using the public PIN;
the server looking up the secret PIN using the public PIN;
the server generating a decryption factor based on the secret PIN that can be used by the client in conjunction with the secret PIN to decrypt the encrypted content;
the server transmitting the encrypted content and the decryption factor to the client.

39. The method of claim 38, further comprising:
the client deriving a decryption key using the decryption factor and the secret PIN;
the client decrypting the encrypted content using the decryption key.

40. The method of claim 38, wherein:
the encrypted content is for-pay content;
the registration phase includes the client forwarding to the server payment information; and
the downloading phase includes the client authorizing payment for the for-pay content.

41. The method of claim 38, wherein:
the secret PIN is reliably generated by the client anytime it is needed; and
neither the secret PIN nor data used to generate the secret PIN are stored on the client.
